(19) United States
(12) Patent Application Publication
(10) Pub. No.: US 2026/0192382 A1
(43) Pub. Date: Jul. 9, 2026

(54) WELDING OF DISSIMILAR MATERIALS WITH DYNAMIC CONFIGURATION OF LASER BEAMS

(71) Applicant: International Business Machines Corporation, Armonk, NY (US)

(72) Inventors: Sarbajit Kumar Rakshit, Kolkata (IN); Sathya Santhar, Ramapuram (IN); Sridevi Kannan, Katupakkam (IN)

(21) Appl. No.: 19/010,315

(22) Filed: Jan. 6, 2025

(51) Int. Cl. B23K 26/042; B23K 26/03

(52) U.S. Cl. CPC B23K 26/042; B23K 26/03

(57) ABSTRACT

A computer-implemented method is provided. Aspects include configuring beam parameters of at least one laser of a set of lasers based on a target welding strength associated with welding together a first material and a second material and characteristics of the first material and the second material. Aspects include controlling the set of lasers in association with welding together the first material and the second material, wherein controlling the set of lasers is based at least in part on configuring the beam parameters of the at least one laser.

### BACKGROUND

The present disclosure generally relates to welding of dissimilar materials, and more specifically, to welding of dissimilar materials with a dynamic configuration of laser beams for achieving a target welding strength and synchronization between the laser beams. More specifically, the present disclosure relates to artificial intelligence (AI)-enabled welding of dissimilar materials with a dynamic configuration of laser beams for achieving the target welding strength and synchronization between the laser beams.

Some industries and manufacturing processes may include joining dissimilar materials as parts of machines, tools, and the like. Techniques for effectively joining dissimilar materials are desired.

### SUMMARY

Example embodiments of the present disclosure are directed to computer-implemented methods including configuring beam parameters of at least one laser of a set of lasers based on: a target welding strength associated with welding together a first material and a second material; and characteristics of the first material and the second material. The computer-implemented methods include controlling the set of lasers in association with welding together the first material and the second material, wherein controlling the set of lasers is based at least in part on configuring the beam parameters of the at least one laser.

Example embodiments also include a computer system including: a processor set; one or more computer-readable storage media; and program instructions stored on the one or more computer-readable storage media to cause the processor set to perform operations including: configuring beam parameters of at least one laser of a set of lasers based on: a target welding strength associated with welding together a first material and a second material; and characteristics of the first material and the second material. The operations include controlling the set of lasers in association with welding together the first material and the second material, wherein controlling the set of lasers is based at least in part on configuring the beam parameters of the at least one laser.

Example embodiments include a computer program product including: one or more computer-readable storage media; and program instructions stored on the one or more storage media to perform operations including configuring beam parameters of at least one laser of a set of lasers based on: a target welding strength associated with welding together a first material and a second material; and characteristics of the first material and the second material. The operations include controlling the set of lasers in association with welding together the first material and the second material, wherein controlling the set of lasers is based at least in part on configuring the beam parameters of the at least one laser.

Other embodiments of the present invention implement features of the above-described method in computer systems and computer program products.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings.

FIG. 1 illustrates a block diagram of an example computer system for use in conjunction with one or more embodiments of the present disclosure.

FIG. 2 illustrates a block diagram of an example system that supports AI-enabled welding of dissimilar materials in accordance with one or more embodiments of the present disclosure.

FIGS. 3 through 7 illustrate example flowcharts of methods that support AI-enabled welding of dissimilar materials in accordance with one or more embodiments of the present disclosure.

FIG. 4 is a flowchart of a method in accordance with one or more embodiments of the present disclosure.

FIG. 5 is a flowchart of a method in accordance with one or more embodiments of the present disclosure.

FIG. 6 is a flowchart of a method in accordance with one or more embodiments of the present disclosure.

FIG. 7 is a flowchart of a method in accordance with one or more embodiments of the present disclosure.

FIG. 8 illustrates an example flowchart of a method that supports AI-enabled welding of dissimilar materials in accordance with one or more embodiments of the present disclosure.

### DETAILED DESCRIPTION

Some industries and manufacturing processes may include joining dissimilar materials as parts of machines, tools, and the like. When welding dissimilar materials, a welder may consider several factors in association with obtaining a ensure a strong, crack-free joint. In some aspects, the types of metal, the weld material, and the temperature may affect the welding. Such factors are a handful of considerations a welder may take into consideration when choosing a method for joining dissimilar materials. With expert knowledge and the right tools, some welders may be able to create successful joints between many dissimilar metals.

Dissimilar welding refers to the process of connecting materials with different alloys through welding. In some approaches, the filler material and the materials (metals) to be connected may be evaluated before choosing how to connect the metals. While fusion welding is a popular method, fusion welding fails to succeed for some combinations of metals. Other methods may provide a more durable hold, especially for uses in high-stress environments.

However, some welding methods struggle to achieve the strength supportive of effectively joining dissimilar materials with divergent properties such as, for example, melting points, thermal expansion, electrochemical characteristics, and solubility.

In accordance with one or more embodiments of the present disclosure, an AI-enabled laser welding system is provided which supports precise alignment of multiple laser beams for welding dissimilar materials, facilitating efficient welding and overcoming the complexities associated with joining dissimilar materials.

In accordance with one or more embodiments of the present disclosure, an AI enabled laser welding system is provided which may utilize two laser beams with distinct powers and configurations aligned to the melting points, thermal expansion, electrochemical properties, and solubility of dissimilar materials, ensuring welding with a welding strength supportive of successful welding of the dissimilar materials. In some aspects, the AI enabled laser welding system may use historical learning in association with determining a target penetration (penetration depth) between dissimilar materials for achieving the welding strength.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

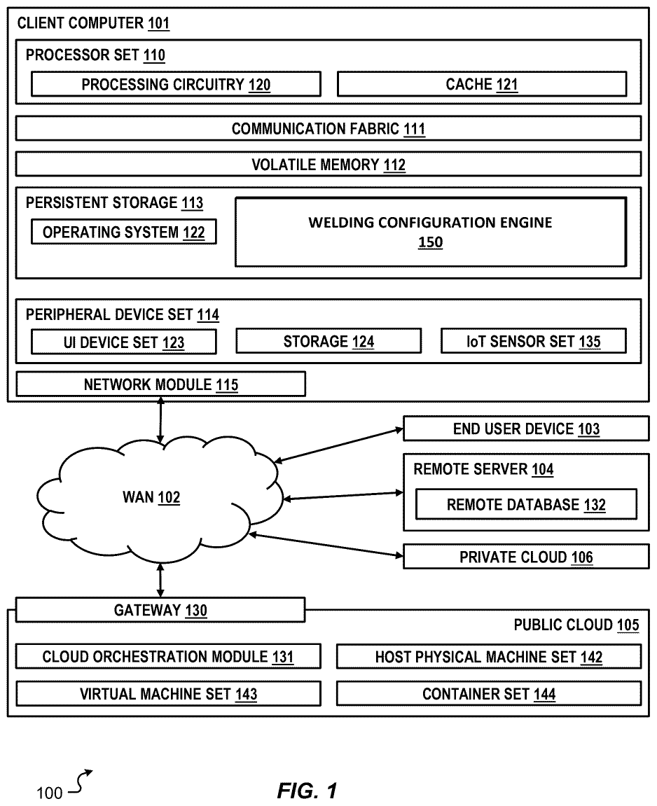

FIG. 1 illustrates a block diagram of an example computer system for use in conjunction with one or more embodiments of the present disclosure. Computing environment 100 contains an example of an environment for the execution of at least some of the computer code involved in performing the inventive methods, such as AI-enabled welding of dissimilar materials using the welding configuration engine 150 or an application deployed on the welding configuration engine 150. In addition to welding configuration engine 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and welding configuration engine 150, as identified above), peripheral device set 114 (including user interface (UI), device set 123, storage 124, and Internet of Things (IoT) sensor set 135), and network module 115. Remote server 104 includes remote database 132. Public Cloud 105 includes gateway 130, Cloud orchestration module 131, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in welding configuration engine 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in welding configuration engine 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 135 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 105 is performed by the computer hardware and/or software of Cloud orchestration module 131. The computing resources provided by public Cloud 105 are typically implemented by virtual computing environments that run on various computers making up the computers of host physical machine set 142, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 131 manages the transfer and storage of images, deploys new instantiations of VCEs and manages active instantiations of VCE deployments. Gateway 130 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

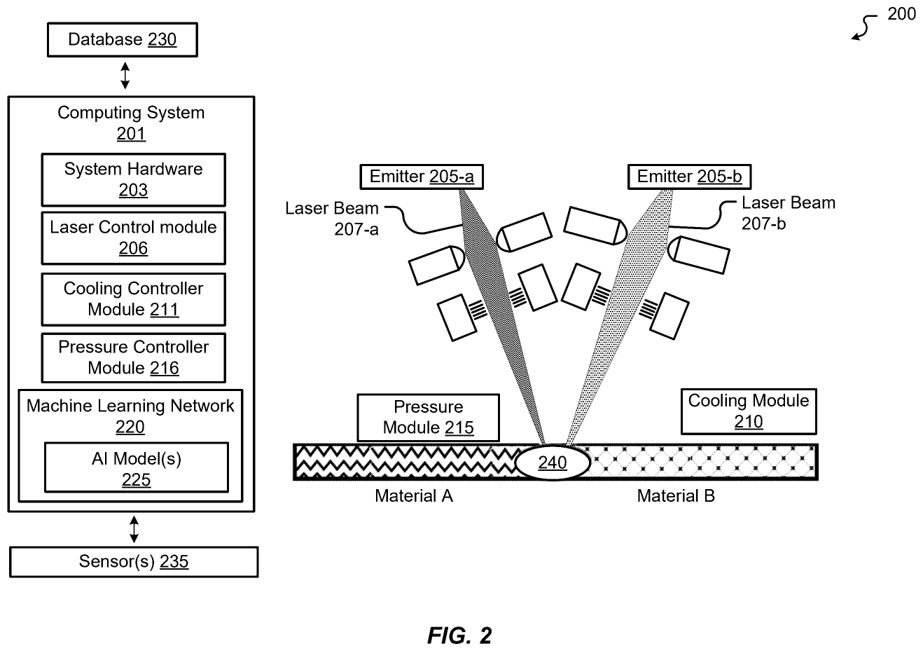

FIG. 2 illustrates a block diagram of an example system 200 that supports AI-enabled welding of dissimilar materials in accordance with one or more embodiments of the present disclosure. The system 200 may be referred to as a laser welding system. The system 200 may include a computing system 201.

All or a portion of the computing system 201 shown in FIG. 2 can be implemented, for example, by all or a subset of the computing environment 100 of FIG. 1. In one or more embodiments, the computing system 201 is embodied in a computer 101 as the one shown in FIG. 1. In one or more embodiments, the computing system 201 is embodied in an end user device 103 as the one shown in FIG. 1. Aspects of the computing system 201 may be implemented by the welding configuration engine 150 illustrated at FIG. 1.

The system 200 includes a computing system 201, emitters 205 (e.g., emitter 205-a, emitter 205-b), a cooling module 210, a pressure module 215, a database 230, and sensors 235. Components of the system 200 may communicate or exchange data using wired or wireless communication techniques.

The computing system 201 may control the overall operation of the welding process described herein. The computing system 201 includes system hardware 203, a laser control module 206, cooling controller module 211, a pressure controller module 216, and a machine learning network 220.

The system hardware 203 includes the central processing units (CPUs), graphical processing units (GPUs), memory, and the like that are part of the computing system. The system hardware 203 executes computer code stored at a memory (e.g., volatile memory 112, persistent storage 113, storage 124, and the like described with reference to FIG. 1) of the computing system 201.

The laser control module 206 may provide control signals to emitter 205-a and emitter 205-b in association with respectively generating laser beam 207-a and laser beam 207-b. For example, the laser control module 206 may provide control signals in association with setting beam parameters (e.g., beam strength, beam duration, beam type, and beam direction) of laser beam 207-a and laser beam 207-b as respectively generated by emitter 205-a and emitter 205-b. In some examples, the control signals may set or target specific areas on Material A and Material B. Each of emitter 205-a and emitter 205-b may be referred to as a laser beam welding module.

The controller module 211 may provide control signals to the cooling module 210 in association with regulating a cooling process during welding. The cooling module 210 may perform operations supportive of cooling the materials and regulating the cooling process during welding using, for example, air, liquid, or the like.

The pressure controller module 216 may provide control signals to the pressure module 215 in association with applying pressure. For example, the pressure controller module 216 may control the pressure module 215 in association with applying a target pressure (e.g., to Material A and/or Material B) in association with achieving a target penetration and a target joint strength.

Machine learning network 220, which includes AI model(s) 225, may implement operations for processing data and making real-time adjustments in association with AI-enabled welding of dissimilar materials, example aspects of which are later described herein.

Database 230 may include stored specifications of materials (e.g., of Material A, Material B, and other materials) and historical data associated with welding combinations of the materials, example aspects of which are described herein.

Sensors 235 may be configured to provide sensor data associated with a welding process implemented by the system 200. Non-limiting examples of the sensor data include temperature of the materials (e.g., of Material A and/or Material B), pressure applied by pressure module 215, image data (e.g., of Material A and/or Material B), state information (e.g., of Material A and/or Material B), and other parameters during the welding process.

The system 200 may dynamically configure properties of the laser beam 207-a and laser beam 207-b based on the properties of the materials and a target welding strength, and further, ensure synchronized control of the laser beam 207-a and laser beam 207-b and effective welding of the materials.

The system 200 is capable of receiving material properties of dissimilar materials (e.g., Material A and Material B), target welding strength, level of penetration, dimension specification of the materials. Based on the material properties, the system 200 may dynamically configure each of laser beam 207-a and laser beam 207-b differently with a respective beam strength, and further, control or move the laser beam 207-a and the laser beam 207-b in a synchronized manner. The system 200 may provide multiple laser beams 207 with different respective beam strengths, aligned with the deviation in the material properties of the dissimilar materials.

The computing system 201 may utilize data stored in a corresponding memory (e.g., memory of a computer 101, memory of a EUD 103, memory at a remote server 104, and the like) as the machine learning network 220. Machine learning network 220 may include a machine learning architecture. In some aspects, the machine learning network 220 may be or include one or more classifiers. In some other aspects, the machine learning network 220 may be or include any suitable machine learning network such as, for example, a deep learning network, a convolutional neural network, or the like. Some functions of the computing system 201 may be implemented using machine learning techniques.

The machine learning network 220 may include a machine learning model(s) (e.g., AI model 225) which may be trained and/or updated based on data (e.g., training data) provided or accessed by the computing system 201. The machine learning model(s) may be built and updated by the computing system 201 based on the training data (also referred to herein as training data and feedback). In some aspects, the machine learning model(s) may be built and updated by the computing system 201 based on data generated by and/or operations performed by the system 200.

The computing system 201 may be integrated with or be electrically coupled to a user interface. User interface can be implemented by device set 123 of FIG. 1. The computing system 201 may provide (e.g., visually, audibly, and the like) instruction data of a user manual via the user interface.

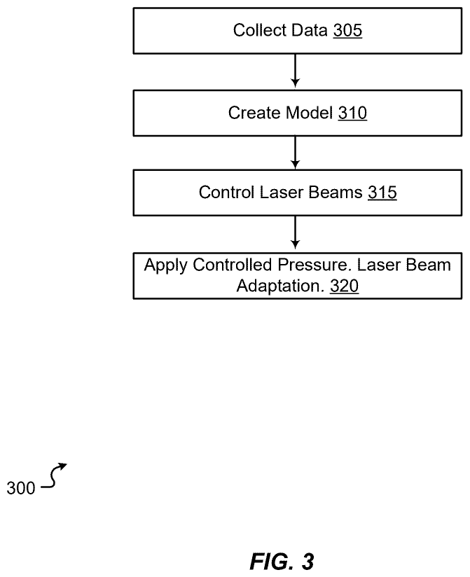

FIGS. 3 through 7 illustrate example flowcharts of methods that support AI-enabled welding of dissimilar materials in accordance with one or more embodiments of the present disclosure.

The methods may be implemented by the example aspects of a system (e.g., computing environment 100, system 200) as described herein. In the descriptions of the flowcharts herein, the operations may be performed in a different order than the order shown, or the operations may be performed in different orders or at different times. Certain operations may also be left out of the flowcharts, one or more operations may be repeated, or other operations may be added to the flowcharts.

With reference to FIG. 3, at block 305, the method 300 may include historically collecting and aggregating data on welding strength with respect to different types of dissimilar material welding. At block 310, the method 300 may include creating a trained model (e.g., AI model 225) based on the historical data associated with welding dissimilar materials. At block 315, the method 300 may include controlling and utilizing, by the system 200, laser beams 207 (e.g., laser beam 207-a and laser beam 207-b) for welding dissimilar materials (e.g., Material A, Material B). At block 320, the method 300 may include applying controlled pressure and performing real-time adaptation of the laser beams 207 individually.

In a non-limiting example, Material A may be a relatively soft material (e.g., aluminum or aluminum alloy), and Material B may be a relatively hard material (e.g., iron or iron alloy), but embodiments of the present disclosure are not limited thereto.

It is to be understood that although the examples provided herein are described with reference to two dissimilar materials (e.g., Material A, Material B) having different material properties, embodiments of the present disclosure are not limited thereto. For example, the systems and techniques described herein may support implementations for welding three or more dissimilar materials. Further, for example, the systems and techniques described herein are not limited to welding dissimilar materials. That is, for example, the systems and techniques described herein may be implemented in association with welding materials having the same material properties.

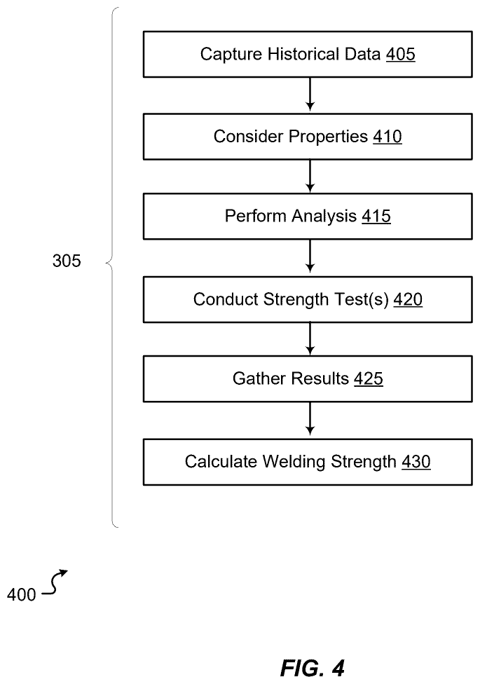

Example aspects of the operations implemented at block 305 through block 320 are further respectively described at FIG. 4 through FIG. 7.

FIG. 4 is a flowchart of a method 400 in accordance with one or more embodiments of the present disclosure. The method 400 includes aspects of 305 of the method 300 of FIG. 3.

At block 405, the method 400 may include capturing historical data. The historical data may include historical welding strength of various combinations of dissimilar reference materials. The method 400 may include capturing the historical welding strength in consideration of or based on imaging data as captured by a sensor 235 (e.g., an image sensor). The imaging data may include microscopic imaging of a joint (or joints) at which dissimilar reference materials are welded together. The method 400 may include determining, based on the imaging data, integrity of the joint (or joints) with respect to strength and a type (e.g., tensile strength, shear strength) of the strength. Accordingly, for example, the historical data may include historical welding data of various dissimilar reference materials, joint integrity associated with welding the dissimilar reference materials, and different types of strength associated with the joints which weld together the dissimilar reference materials.

At block 410, the method 400 may include considering the properties of dissimilar reference materials which are being welded or dissimilar reference materials which were welded together. For example, with respect to the historical welding strength of dissimilar reference materials, the method 400 may include linking or correlating the properties of materials welded together with the historical welding strength between the materials. Non-limiting examples of the properties include melting points, thermal expansion coefficients, electrochemical properties, and solubility of each material.

At block 415, the method 400 may include performing microscopic analysis of welding results using image analysis systems implemented at the computing system 201. For example, the method 400 may include identifying, based on the image analysis, the penetration of a joint at which dissimilar reference materials are welded.

At block 420, the method 400 may include conducting welding strength tests using candidate dissimilar reference materials. The welding strength tests may include creating a sample joint (a welded joint) with the dissimilar reference materials, for example, through a welding operation.

At block 425, the method 400 may include gathering mechanical testing results associated with the sample joint (welded joint) via one or more tests. Non-limiting examples of the tests may include tensile testing or shear testing.

At block 430, the method 400 may include calculating the welding strength of the joint (or joints) at which dissimilar reference materials are welded, based on the level of penetration of the joint (or joints). The method 400 may include determining the welding strength based on the maximum stress the joint can withstand before failure.

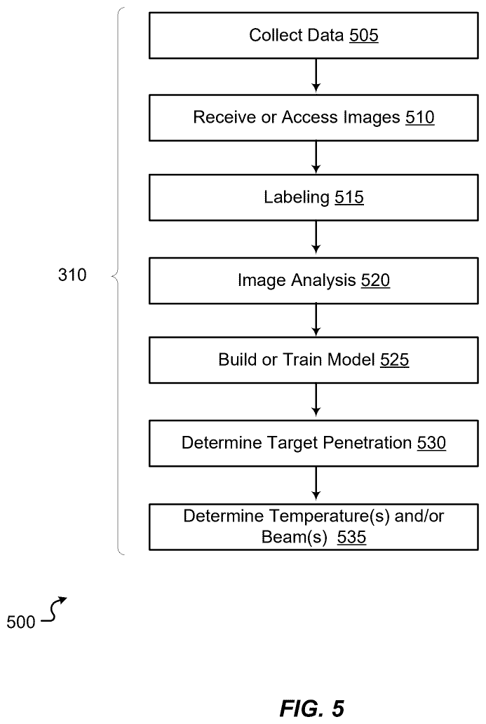

FIG. 5 is a flowchart of a method 500 in accordance with one or more embodiments of the present disclosure. The method 500 includes aspects of 310 of the method 300 of FIG. 3.

At block 505, the method 500 may include collecting data from welding of dissimilar reference materials. For a given set of dissimilar reference materials welded together, the data may include microstructure images based on which the method 500 may identify the welding penetration and overlap area, welding strength (e.g., tensile and shear strength), and properties of the dissimilar reference materials. Non-limiting examples of the properties may include melting points, thermal expansion, electrochemical properties, and solubility.

At block 510, the method 500 may include receiving or accessing microstructure images of the joint penetration. In some examples, the method 500 may include receiving or accessing the microstructure images from a sensor (e.g., sensors 235) and/or the database 230. Based on the microstructure images, the method 500 may include identifying welding penetration and overlap areas between dissimilar reference materials, utilizing techniques such as, for example, image processing and computer vision.

At block 515, based on the testing of the welding strength (e.g., as implemented at block 420 and block 425 of FIG. 4), the method 500 may include labeling the macrostructural portion of the joint with corresponding welding strength values (e.g., tensile strength, shear strength).

At block 520, the method 500 may include analyzing the microstructure image. For example, the method 500 may include processing the microstructure image using one or more convolutional neural networks (CNNs) for the analysis of the microstructure image of penetration.

At block 525, the method 500 may include building or training the AI model 225. For example, the method 500 may include integrating material properties of the dissimilar reference materials into the AI model 225. For example, the method 500 may include integrating, into the model, a correlation associated with dissimilarities between dissimilar reference materials and resultant joint strength. For example, the correlation may include a consideration of how different dissimilarities in properties of dissimilar reference materials may result in different joint strengths.

At block 530, the method 500 may include determining, using the AI model 225, a target amount (depth) of penetration which may ensure a target joint strength of the weld between dissimilar reference materials. The method 500 may include determining, using the AI model 225 target respective temperatures of the dissimilar reference materials for ensuring the target amount (depth) of penetration. For example, the method 500 may include determining a target change in temperature (amount of temperature increase) for each of the dissimilar reference materials which may ensure the target amount (depth) of penetration.

At block 535, for the dissimilar reference materials, the method 500 may include determining whether the target change in temperature for the first reference material is equal to or different from the target change in temperature for the second reference material. In an example, based on determining the target change in temperature for the first reference material is different from the target change in temperature for the second reference material, the method 500 may conclude that different respective temperatures or different respective laser beams are to be applied in association with welding the dissimilar reference materials.

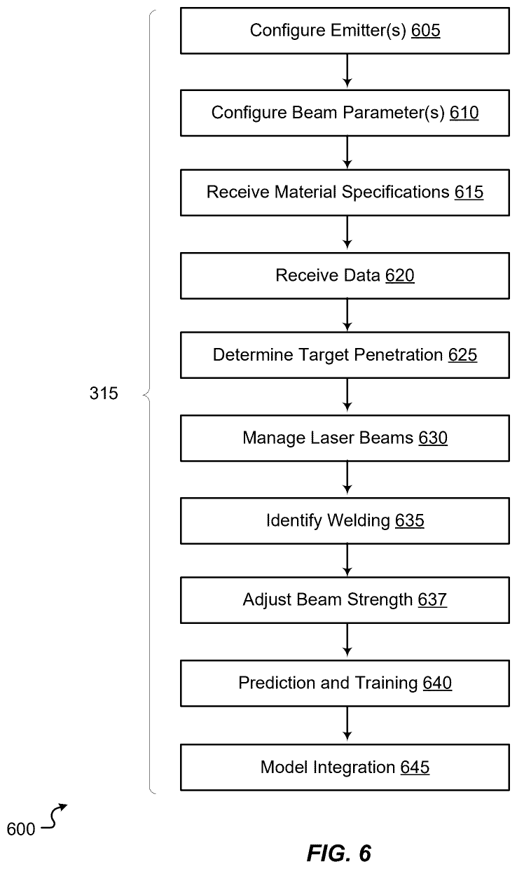

FIG. 6 is a flowchart of a method 600 in accordance with one or more embodiments of the present disclosure. The method 600 includes aspects of 315 of the method 300 of FIG. 3.

At block 605, the method 600 may include configuring the emitter 205-a and the emitter 205-b. The emitter 205-a and the emitter 205-b may each be capable of emitting a laser beam 207 of a respective laser beam type and laser beam strength. The system 200 (a laser welding system) may be controlled by an AI-enabled system (e.g., as implemented at computing system 201) in association with implementing the method 600, and the method 600 may include selecting different strengths for the laser beams 207 respectively emitted by emitters 205.

At block 610, the method 600 may include configuring beam parameters of the laser beams 207. For example, the method 600 may include individually controlling the emitter 205-a and emitter 205-b of the laser beam welding system such that the emitter 205-a and the emitter 205-b respectively emit laser beam 207-a and laser beam 207-b having different respective beam parameters (e.g., beam strength). The method 600 may include configuring the laser beam 207-a and laser beam 207-b according to specific target parameters, such as, for example, beam strength (i.e., power levels) and beam alignment.

At block 615, the method 600 may include receiving material specifications of materials (e.g., Material A and Material B, for example, dissimilar materials) to be welded. The method 600 may include identifying material properties (e.g., melting points, thermal expansion, electrochemical properties, and solubility) of the materials from database 230.

At block 620, the method 600 may include receiving data indicating a target strength according to which the materials are to be welded. The target strength may be a target strength of an intended welding joint between the materials. In an example, the method 600 may include receiving the data (i.e., indication of the target strength) via a user input manually provided via a user interface described herein.

At block 625, the method 600 may include determining, using the computing system 201 (i.e., AI-enabled system) a target level of penetration for welding the materials. For example, the method 600 may include determining the target level of penetration based on respective dimensions of the materials. In some aspects, the method 600 may include determining the target level of penetration based on the respective dimensions of the materials in combination with the material properties of the materials and/or the target strength indicated at block 620.

At block 630, the method 600 may include managing and synchronizing the laser beams 207. For example, once the materials are to be joined with welding, the method 600 may include determining relative positions of the materials with respect to one another. In an example, based on determining (identifying) the materials are within a threshold distance of one another (e.g., the materials are relatively close to one another), the method 600 (e.g., by the computing system 201 using AI-enabled techniques described herein) may manage and synchronize the control and emission of the laser beams 207 by the emitters 205 based on the material properties of the materials.

At block 635, the method 600 may include identifying the type(s) of welding to be performed and the region(s) 240 (i.e., location(s)) on the materials at which to weld the materials.

At block 637, based on the type(s) of welding and the region(s) 240 identified at block 635, the method 600 may include adjusting beam strength (i.e., beam power level), beam configurations, and beam alignment of the laser beams 207 accordingly.

At block 640, the method 600 may include prediction using the AI model 225 and/or training (e.g., further training) of the AI model 225. As described herein, the AI model 225 may be a machine learning model that may take into account historical data on welding of dissimilar reference materials. In an example, at block 640, the method 600 may include training (e.g., further training) the AI model 225 on the historical data. In accordance with the training, the AI model 225 may be capable of effectively predicting beam configurations and beam strengths (i.e., beam power levels) for achieving a target welding strength between materials (e.g., Material A, Material B), based on material properties of the materials.

At block 645, the method 600 may include integrating the AI model 225 (machine learning model) with the computing system 201 and included control systems (e.g., laser control module 206). Based on the integration, the computing system 201 may be capable of effectively performing real-time decision-making inclusive of dynamically adjusting beam parameters (also referred to herein as beam properties) during the welding process. For example, the method 600 may include repeating or continuously performing any of the operations described herein based on the further training and integration of the AI model 225.

The training data used in the creation, training, and retraining of the AI model 225 described herein may be structured or unstructured data. According to one or more embodiments described herein, the training data includes configurations of computing systems and performance metrics obtained from the computing systems during the execution of calibration programs. The training can be supervised learning, semi-supervised learning, unsupervised learning, reinforcement learning, and/or the like, including combinations and/or multiples thereof. In some aspects, using the AI model 225, the computing system 201 may generate predictions based on which the computing system 201 may control AI-enabled welding of dissimilar materials in accordance with one or more embodiments of the present disclosure.

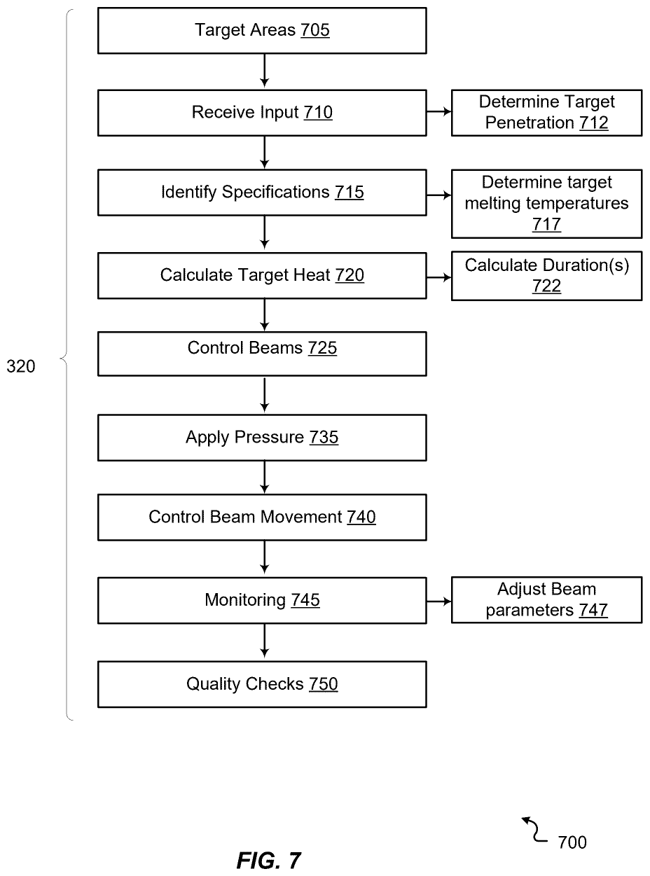

FIG. 7 is a flowchart of a method 700 in accordance with one or more embodiments of the present disclosure. The method 700 includes aspects of 320 of the method 300 of FIG. 3.

At block 705, the method 700 may include targeting specific areas (e.g., region(s) 240) on Material A and Material B as per the design of the welding, such as, for example, spot welding.

At block 710, the method 700 may include receiving a design input associated with the welding. In an example, the design input may include a target welding strength for the welding.

At block 712, based on the design input (e.g., the target welding strength), the method 700 may include, using the AI-based techniques described herein, determining a target penetration of Material A and Material B.

At block 715, the method 700 may include identifying the specifications (e.g., properties such as, for example, melting points, thermal expansion, and the like) of Material A and Material B.

At block 717, based on the specifications, the method 700 may include, using the AI-based techniques described herein, determining or identifying respective target melting temperatures for Material A and Material B which support welding Material A and Material B.

At block 720, the method 700 may include calculating a target amount of heat for Material A and Material B based on the region(s) 240 of Material A and Material B to be joined under welding.

At block 722, based on the calculated target amount of heat, the method 700 may include calculating respective durations (i.e., beam durations) for heating each of the Material A and Material B. The durations may be amounts of time according to which the system 200 may apply laser beam 207-a and/or laser beam 207-b to Material A and/or Material B in association with applying the calculated target amount of heat.

At block 725, the method 700 may include controlling the beam power, duration, and focus of the laser beam 207-a and the laser beam 207-b. For example, the method 700 may include controlling emission of the laser beam 207-a and the laser beam 207-b such that the heating provided by the laser beam 207-a and the laser beam 207-b is synchronized between the emitter 205-a and the emitter 205-b. Accordingly, for example, by controlling the beam power, duration, and focus of the laser beam 207-a and the laser beam 207-b, the method 700 may control the rate of welding and the rate in which the temperature increases.

In some aspects, in association with controlling the laser beam 207-a and the laser beam 207-b at block 725, the method 700 may include controlling the movement and focus of each of laser beam 207-a and laser beam 207-b using mirrors, lenses, or other optical components.

In some aspects, the method 700 may include controlling the laser beam 207-a and the laser beam 207-b at the defined target region(s) 240. In association with controlling the laser beam 207-a and the laser beam 207-b, the method 700 may include adjusting beam strength and duration associated with applying the laser beam 207-a and the laser beam 207-b, based on target parameters (e.g., welding parameters) as determined by the system 200 in accordance with one or more embodiments of the present disclosure.

At block 735, the method 700 may include using a robotic system to create or apply pressure on the dissimilar materials, so that the melt pool gradually solidifies and creates the required joint and penetration.

In some aspects, the method 700 may include applying controlled pressure at the targeted region(s) 240. For example, the method 700 may include using pressure controller module 216 and a robotic system in association with controlling the pressure module 215. The method 700 may include controlling the pressure in synchronization with the laser welding process provided by the system 200.

In some aspects, at block 740, the method 700 may further include moving both laser beam 207-a and laser beam 207-b together (e.g., in synchronization) in association with welding Material A and Material B.

At block 745, the method 700 may include monitoring the welding process using feedback from sensors 235. The monitoring may be continuous or semi-continuous (e.g., periodic, based on a schedule, or based on other trigger criteria). For example, at block 750, the sensors 235 may include temperature sensors, pressure sensors, image sensors, and the like. The method 700 may include monitoring temperatures, physical state (e.g., as determined based on temperatures and/or via the image sensors), and pressure applied at each of Material A and/or Material B.

At block 747, the method 700 may include adjusting beam parameters of the laser beams 207 provided by the emitters 205 in real-time, based on the monitored data of 745.

At block 750, the method 700 may include performing quality checks. For example, at block 750, the method 700 may include comparing joint strength of the welding between the Material A and Material B against a target joint strength as determined using the systems and techniques described herein. Accordingly, for example, by performing the quality checks, the method 700 may ensure the joint strength meets the required standards.

It is to be understood that embodiments of the present disclosure support storing any of the information and data determined and generated in accordance with the techniques described herein to the database 230, and further, training or retraining of the AI models 225 described herein based on such information and data.

As has been described herein, an AI enabled laser welding system is provided which may utilize laser beams (e.g., two laser beams) with distinct powers and configurations aligned to the melting points, thermal expansion, electrochemical properties, and solubility of dissimilar materials, ensuring welding with a strength supportive of effective welding of the dissimilar materials.

The systems and techniques described herein provide a method which may consider historical learning and determine, based on the historical learning, penetration amounts supportive of achieving a target welding strength (e.g., a required welding strength) for welding dissimilar materials.

In accordance with one or more embodiments of the present disclosure, a laser welding model (e.g., laser control module 206, emitter 205) described herein may target specific areas on dissimilar materials, apply controlled beam strength according to a target duration, along with controlled pressure, in association with achieving a target joint strength at those specific areas.

The systems and techniques described herein provide a method which may dynamically adapt the laser beam parameters in association with ensuring synchronized movement of multiple laser beams for welding of dissimilar materials in a seamless manner, ensuring penetration and strength which satisfies target criteria.

In some aspects, the systems and techniques described herein may include measuring or determining the amount of heat which propagates from a portion of first material (e.g., Material A) to a second material (e.g., Material B) due to the application of a given laser beam (e.g., laser beam 207-a) to the Material A. For example, the systems and techniques described herein may include determining the propagation of the heat based on distance between a point at which the laser beam is incident the first material to the second material. In some aspects, the systems and techniques described herein may control the emitter 205-a and/or emitter 205-b (e.g., control the beam parameters) based on the propagation information.

The systems and techniques described herein provide a laser-based welding method which may, using a pressure generation module (e.g., pressure module 215), apply a pressure for welding together multiple materials after individual melting of the materials, in which the pressure is suitable for achieving target penetration and joint strength.

The systems and techniques described herein provide various advantages and technical improvements compared to some other approaches.

In accordance with one or more embodiments of the present disclosure, the systems may utilize multiple laser beams (e.g., two laser beams) with distinct emission powers, aligned with the melting and semi-melting temperatures of dissimilar materials to be joined together. Once both materials reach their respective melting temperatures, the systems may apply controlled pressure to weld the dissimilar materials.

In some aspects, the systems may take into account the material properties of dissimilar materials to be welded, and using historical learning, the proposed systems may determine a target penetration between the materials in the joint, and accordingly, it may identify the amount of melting power in the dissimilar materials for welding with a target welding strength.

In some aspects, to achieve the target welding strength for multiple dissimilar materials, the laser welding module may target specific areas on both materials and apply the controlled laser beam for an appropriate duration of time for welding the materials. In some aspects, with controlled pressure, the systems described herein may achieve a target penetration at the joint location.

In some aspects, for various welding methods (e.g., spot welding, continuous welding), the systems described herein may regulate the synchronized and parallel motion of the multiple laser beams pointing to respective dissimilar materials placed side by side for welding. Accordingly, for example, the regulation of the synchronized and parallel motion may ensure the individual melting of the dissimilar materials, facilitating welding with a target level of penetration.

In some aspects, the laser-based welding of dissimilar materials as described herein may incorporate a pressure generation module. Using the pressure generation module during the individual melting of the target dissimilar materials, the systems described herein may apply an appropriate pressure suitable for achieving the target level of penetration and joint strength.

In accordance with one or more embodiments of the present disclosure, an AI-based system is provided which may consider the material properties of two dissimilar materials, including melting points, thermal expansion, electrochemical properties, and solubility of each material. In an example, based on historical learning, the system may select respective temperatures for two distinct laser beams and use an appropriate ratio of a third material to achieve a target welding strength between the two dissimilar materials.

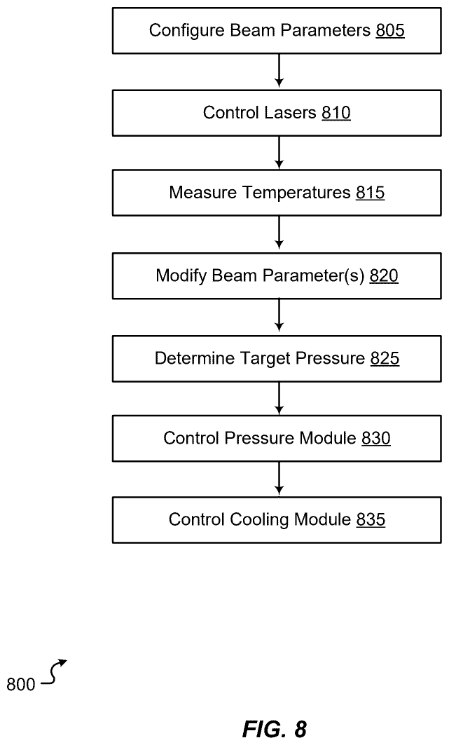

FIG. 8 illustrates an example flowchart of a method that supports AI-enabled welding of dissimilar materials in accordance with one or more embodiments of the present disclosure.

At block 805, the method 800 may include configuring beam parameters of at least one laser of a set of lasers based on: a target welding strength associated with welding together a first material and a second material; and characteristics of the first material and the second material.

In some aspects, the characteristics are selected from the group consisting of a melting point, thermal expansion, an electrochemical property, and solubility.

In some aspects, the beam parameters are selected from the group consisting of beam strength, beam duration, beam type, and beam direction.

In some aspects, the method 800 may include determining a target penetration depth associated with the first material, the second material, or both, based on the target welding strength and the characteristics of the first material and the second material. In some aspects, configuring (at block 805) the beam parameters of the at least one laser is based on the target penetration depth.

In some aspects, the method 800 may include determining a first target area of the first material and a second target area of the second material, based on the target welding strength and the characteristics of the first material and the second material. In some aspects, configuring (at block 805) the beam parameters of the at least one laser is based on the first target area, the second target area, or both.

In some aspects, the method 800 may include determining a target temperature associated with the first material, the second material, or both, based on the target welding strength and the characteristics of the first material and the second material. In some aspects, configuring (at block 805) the beam parameters of the at least one laser is based on the target temperature.

At block 810, the method 800 may include controlling the set of lasers in association with welding together the first material and the second material, where controlling the set of lasers is based on configuring the beam parameters of the at least one laser.

In some aspects, configuring (at block 805) the beam parameters of the at least one laser of the set of lasers includes: configuring the beam parameters of each laser of the set of lasers. In some aspects, controlling (at block 810) the set of lasers is based on configuring the beam parameters of each laser of the set of lasers.

In some aspects, controlling (at block 810) the set of lasers includes synchronizing movement of the set of lasers in association with obtaining the target welding strength and a target penetration depth.

At block 815, the method 800 may include measuring a first temperature at the first material and a second temperature at the second material.

At block 820, the method 800 may include modifying at least one beam parameter of the beam parameters of the at least one laser based on the first temperature, the second temperature, or both.

At block 825, the method 800 may include determining a target pressure associated with welding together the first material and the second material, based on at least one of: the target welding strength; the characteristics of the first material and the second material; and the beam parameters of the at least one laser.

At block 830, the method 800 may include controlling a pressure module in association with applying a force to at least one of the first material and the second material based on the target pressure.

In some aspects, the method 800 may include measuring a first temperature at the first material and a second temperature at the second material; and determining a state of the first material and a state of the second material.

In some aspects, at block 830, the method 800 may include controlling the pressure module in association with applying a force to at least one of the first material and the second material based on at least one of: determining the first temperature and the second temperature satisfy respective target temperatures associated with welding together the first material and the second material; and determining the state of the first material and the state of the second material satisfy respective target states associated with welding together the first material and the second material.

At block 835, the method 800 may include controlling a cooling module in association with cooling the first material, the second material, or both, based on a target temperature and the beam parameters of the at least one laser. For example, the method 800 may include determining the target temperature associated with the first material, the second material, or both, based on the target welding strength and the characteristics of the first material and the second material.

In some aspects, the method 800 may include: processing, by a machine learning model, the target welding strength and the characteristics of the first material and the second material; and determining, based on the processing, one or more of parameters selected from the group consisting of: the beam parameters of the at least one laser of the set of lasers; a first target penetration depth associated with the first material, a second target penetration depth associated with the second material, or both; a first target area of the first material and a second target area of the second material; movement parameters associated with synchronizing movement of the set of lasers; a target pressure associated with welding together the first material and the second material; a first target temperature associated with the first material, a second target temperature associated with the second material, or both; and a target state of the first material, a target state of the second material, or both. In some aspects, the method 800 may include controlling the set of lasers, a pressure module, and a cooling module based on the one or more of parameters.

In some aspects, the method 800 may include: training the machine learning model based on reference data, where the reference data includes beam parameters previously configured for the at least one laser in association with welding the first material with the second material.

In the descriptions of the flowcharts herein, the operations may be performed in a different order than the order shown, or the operations may be performed in different orders or at different times. Certain operations may also be left out of the flowcharts, one or more operations may be repeated, or other operations may be added to the flowcharts.

Various embodiments are described herein with reference to the related drawings. Alternative embodiments can be devised without departing from the scope of the present disclosure. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
configuring beam parameters of at least one laser of a set of lasers based on:
a target welding strength associated with welding together a first material and a second material; and
characteristics of the first material and the second material; and
controlling the set of lasers in association with welding together the first material and the second material, wherein controlling the set of lasers is based at least in part on configuring the beam parameters of the at least one laser.

2. The computer-implemented method of claim 1, further comprising:
determining a target penetration depth associated with the first material, the second material, or both, based on the target welding strength and the characteristics of the first material and the second material,
wherein configuring the beam parameters of the at least one laser is based on the target penetration depth.

3. The computer-implemented method of claim 1, further comprising:
determining a first target area of the first material and a second target area of the second material, based on the target welding strength and the characteristics of the first material and the second material,
wherein configuring the beam parameters of the at least one laser is based on the first target area, the second target area, or both.

4. The computer-implemented method of claim 1, wherein the characteristics are selected from the group consisting of a melting point, thermal expansion, an electrochemical property, and solubility.

5. The computer-implemented method of claim 1, wherein the beam parameters are selected from the group consisting of beam strength, beam duration, beam type, and beam direction.

6. The computer-implemented method of claim 1, wherein:
configuring the beam parameters of the at least one laser of the set of lasers comprises configuring the beam parameters of each laser of the set of lasers; and
controlling the set of lasers is based at least in part on configuring the beam parameters of each laser of the set of lasers.

7. The computer-implemented method of claim 1, further comprising:
measuring a first temperature at the first material and a second temperature at the second material; and
modifying at least one beam parameter of the beam parameters of the at least one laser based on the first temperature, the second temperature, or both.

8. The computer-implemented method of claim 1, wherein controlling the set of lasers comprises synchronizing movement of the set of lasers in association with obtaining the target welding strength and a target penetration depth.

9. The computer-implemented method of claim 1, further comprising:
determining a target pressure associated with welding together the first material and the second material, based on at least one of:
the target welding strength;
the characteristics of the first material and the second material; and
the beam parameters of the at least one laser; and
controlling a pressure module in association with applying a force to at least one of the first material and the second material based on the target pressure.

10. The computer-implemented method of claim 1, further comprising:
determining a target temperature associated with the first material, the second material, or both, based on the target welding strength and the characteristics of the first material and the second material,
wherein configuring the beam parameters of the at least one laser is based on the target temperature.

11. The computer-implemented method of claim 1, further comprising:
determining a target temperature associated with the first material, the second material, or both, based on the target welding strength and the characteristics of the first material and the second material; and
controlling a cooling module in association with cooling the first material, the second material, or both, based on the target temperature and the beam parameters of the at least one laser.

12. The computer-implemented method of claim 1, further comprising:
measuring a first temperature at the first material and a second temperature at the second material;
determining a state of the first material and a state of the second material; and
controlling a pressure module in association with applying a force to at least one of the first material and the second material based on at least one of:
determining the first temperature and the second temperature satisfy respective target temperatures associated with welding together the first material and the second material; and
determining the state of the first material and the state of the second material satisfy respective target states associated with welding together the first material and the second material.

13. The computer-implemented method of claim 1, further comprising:
processing, by a machine learning model, the target welding strength and the characteristics of the first material and the second material;
determining, based on the processing, one or more of parameters selected from the group consisting of:
the beam parameters of the at least one laser of the set of lasers;
a first target penetration depth associated with the first material, a second target penetration depth associated with the second material, or both;
a first target area of the first material and a second target area of the second material;
movement parameters associated with synchronizing movement of the set of lasers;
a target pressure associated with welding together the first material and the second material;
a first target temperature associated with the first material, a second target temperature associated with the second material, or both; and
a target state of the first material, a target state of the second material, or both; and
controlling the set of lasers, a pressure module, and a cooling module based on the one or more of parameters.

14. The computer-implemented method of claim 13, further comprising:
training the machine learning model based on reference data,
wherein the reference data comprises beam parameters previously configured for the at least one laser in association with welding the first material with the second material.

15. A computer system comprising:
a processor set;
one or more computer-readable storage media; and
program instructions stored on the one or more computer-readable storage media to cause the processor set to perform operations comprising:
configuring beam parameters of at least one laser of a set of lasers based on:
a target welding strength associated with welding together a first material and a second material; and
characteristics of the first material and the second material; and
controlling the set of lasers in association with welding together the first material and the second material, wherein controlling the set of lasers is based at least in part on configuring the beam parameters of the at least one laser.

16. The computer system of claim 15, wherein the operations further comprise:
determining a target penetration depth associated with the first material, the second material, or both, based on the target welding strength and the characteristics of the first material and the second material,
wherein configuring the beam parameters of the at least one laser is based on the target penetration depth.

17. The computer system of claim 15, wherein the operations further comprise:
measuring a first temperature at the first material and a second temperature at the second material; and
modifying at least one beam parameter of the beam parameters of the at least one laser based on the first temperature, the second temperature, or both.

18. The computer system of claim 15, wherein controlling the set of lasers comprises synchronizing movement of the set of lasers in association with obtaining the target welding strength and a target penetration depth.

19. The computer system of claim 15, wherein the operations further comprise:
determining a target pressure associated with welding together the first material and the second material, based on at least one of:
the target welding strength;
the characteristics of the first material and the second material; and
the beam parameters of the at least one laser; and
controlling a pressure module in association with applying a force to at least one of the first material and the second material based on the target pressure.

20. A computer program product comprising:
one or more computer-readable storage media; and
program instructions stored on the one or more computer-readable storage media to perform operations comprising:
configuring beam parameters of at least one laser of a set of lasers based on:
a target welding strength associated with welding together a first material and a second material; and
characteristics of the first material and the second material; and
controlling the set of lasers in association with welding together the first material and the second material, wherein controlling the set of lasers is based at least in part on configuring the beam parameters of the at least one laser.
